(19) United States
(12) Patent Application Publication
(10) Pub. No.: US 2008/0179298 A1
(43) Pub. Date: Jul. 31, 2008

(54) METHOD OF DETECTING AN OBJECT TO BE DETECTED IN A JOINING DEVICE, JOINING DEVICE, AND JOINING METHOD

(75) Inventors: Hitoshi NAKAYAMA, Tokyo (JP); Naoki Takeshima, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK CORPORATION, Tokyo (JP)

(21) Appl. No.: 12/020,682

(22) Filed: Jan. 28, 2008

(30) Foreign Application Priority Data
Jan. 29, 2007 (JP) 2007-017713
Jan. 11, 2008 (JP) 2008-004357

(51) Int. Cl. B23K 3/06; B23K 1/005; G01J 5/20; G01J 1/02

(52) U.S. Cl. 219/85.13; 250/370.08; 250/370.1; 219/85.19; 219/85.21; 228/219

(57) ABSTRACT

Provided is a detection method of detecting presence or absence of an object to be detected in an object hold portion that is used together with an irradiation portion that irradiates the object to be detected with a heat ray, holds the object to be detected, and has an opening, the detection method including: imaging an image signal in a predetermined region having the opening by an imaging device; and making an irradiation optical path of the irradiation portion and an imaging optical path of the imaging device substantially coincide with each other within the opening by an optical unit.

### BACKGROUND OF THE INVENTION

1. Field of the Invention

The present invention relates to a joining device in which, an object to be ejected, such as an electrically conductive member made of solder or the like is arranged at a predetermined position of a nozzle, the object to be detected is ejected between objects to be joined, and those members to be joined are joined together. In particular, the present invention relates to an object detection method of detecting that the object to be ejected is arranged at a predetermined position of the nozzle, and a joining device and a joining method which are capable of detecting a position of the object to be detected by the detection method.

2. Description of the Related Art

For example, the manufacture of a magnetic head includes a process of connecting an electrode disposed in a so-called magnetic head core and a wiring end on a so-called gimbal that supports the core. For the process, for example, as disclosed in Japanese Patent Application Laid-open No. 2002-170351A (refer to FIG. 13), there has been known a method in which a solder ball 515 is supplied to a portion close to an electrode 525 and a wiring end 529, and the electrode 525 and the wiring end 529 are electrically connected to each other through the solder ball 515.

In the above method, the solder ball 515 made of an electrically conductive material is used, and there is also used a disk-shaped member 513 on which a plurality of through-holes 517 are arranged with a predetermined distance from the rotation center and at a predetermined angle interval in order to separate the solder balls 515 from a portion where a plurality of solder balls 515 are held one by one. The solder balls 515 that have been inserted into the through-holes 517 due to the rotation of the disk-shaped member 513 are separated and conveyed, individually. The solder ball 515 drops through a conveyance path 511 by its weight at a position where the through-hole 517 communicates with the conveyance path 511 of the solder ball 515, and the solder ball 515 moves to a predetermined supply position. Further, the solder ball 515 is irradiated with a laser beam 503 at the supply position, and melted to electrically connect the electrode 525 and the wiring end 529. In the above method, the conveyance path is also used as a supply path of a nitrogen gas or a nitrogen mixture gas which is supplied in order to prevent oxidation of the solder ball. The nitrogen gas assists in moving the solder ball to the supply position.

With the downsizing or higher performance of a magnetic recording device (so-called HDD: hard disk drive) that is equipped with a magnetic head, the miniaturization and the complication of the structure of the magnetic head have been increasingly advanced in recent years. The diameter of the solder ball becomes remarkably smaller as in the magnetic head, and in the method disclosed in Japanese Patent Application Laid-open No. 2002-170351A, it is difficult to surely hold the solder ball at a predetermined position between the electrode and the wiring end.

A method of coping with the above-mentioned difficulties is disclosed in Japanese Patent Application Laid-open No. 2004-534409A. In the above method, in a nozzle that holds the solder ball within a space defined internally, a supply opening of the solder ball is reduced in diameter, and the inside of the opening is clogged with the solder ball to hold the solder ball. The nozzle that is kept in a holding state is positioned with respect to the electrode without being brought into contact with the electrode, and thereafter the solder ball is melted by the laser beam, and a pressure in the interior of the nozzle is increased to eject the melted solder ball from the opening portion, whereby the melted solder is attached to the electrode at a predetermined position.

Similarly, in the structure disclosed in Japanese Patent Application Laid-open No. 2004-534409A, the solder ball is individually transported by the aid of a rotary disk having the same through-holes as the structure disclosed in Japanese Patent Application Laid-open No. 2002-170351A. The solder ball is conveyed to the laser beam irradiated position by free fall and assist of nitrogen gas. In the structure, the internal space of the nozzle is brought into a substantially hermetically sealed state by the solder ball, and nitrogen gas is fed to the internal space in that state, to thereby step up a pressure within the internal space, which is required to eject the melted solder ball.

With the miniaturization of the electrode sizes or the electrode pitches which is caused by the downsizing of the magnetic head or the like, the diameter of the solder ball to be used is reduced to about 60 μm. In the solder ball of the above size, there occur the attachment of the solder ball to the rotary disk due to static electricity, and an increase in the resistance due to nitrogen within the nozzle with respect to the force of gravity that is exerted on the solder ball. As a result, a period of time required until the solder ball reaches the predetermined position of the nozzle is longer than that of a solder ball having a large diameter.

For that reason, it is difficult to manage whether or not the solder ball reaches the nozzle opening of the nozzle from which the solder ball is ejected on the basis of time. Up to now, in order to determine the arrival of the solder ball to the predetermined position, the pressure in the internal space of the nozzle is measured, and the arrival of the solder ball is sensed by an increase in the pressure. In the method, the determination is conducted on the basis of the fact that the solder ball is transported to the nozzle opening from which the solder ball is ejected by the aid of assist of, for example, a nitrogen gas flow, and even after the nozzle opening is closed by the solder ball, nitrogen gas is supplied to increase the pressure in the internal space of the nozzle up to the predetermined pressure.

However, an increase in the pressure, which is attributable to the closed nozzle opening, requires time. Also, there is a possibility that a period of time until the pressure increases up to the predetermined value varies according to the closed state or the like. For that reason, there is a variation in the standby time such as 1 to 2 seconds in the actual processing, and the standby time per se is long.

Also, in the case of detecting the completion of transporting the solder ball to the predetermined position within the nozzle according to the time or the pressure as in the conventional art, it is necessary to consider the flow rate or the flow velocity of gas such as nitrogen gas that assists the conveyance of the solder ball as a control parameter.

### SUMMARY OF THE INVENTION

The present invention has been made in view of the above circumstances, and therefore an object of the invention is to provide a detection method of surely and rapidly detecting that an object to be detected is held in an object hold portion in a joining device that holds the object to be detected, such as an electrically conductive member made of solder or the like in the object hold portion, and ejects the object to be detected between members to be joined for joining the members to be joined together.

Also, another object of the present invention is to provide a joining device that supplies the object to be detected to the members to be joined by the aid of the object to be detected whose position has been detected by the above method, melts the object to be detected, and joins the members to be joined together.

In order to solve the above-mentioned problems, a first aspect of the present invention relates to a detection method of detecting presence or absence of an object to be detected in an object hold portion that is used together with an irradiation portion that irradiates the object to be detected with a heat ray, holds the object to be detected, and has an opening, the detection method including: imaging an image signal in a predetermined region having the opening by an imaging device; and making an irradiation optical path of the irradiation portion and an imaging optical path of the imaging device substantially coincide with each other within the opening by an optical unit.

In this specification, the electrically conductive member means a member capable of electrically connecting members to be joined together made of a metallic material such as solder or gold, or an alloy. Also, the shape of the electrically conductive member is not limited to a sphere but also includes a cube geometry and a conical body shape.

Also, the object to be detected with no translucency is not limited to a member through which no light passes at all, but also includes a member through which substantially no light passes.

Further features of the present invention will become apparent from the following description of exemplary embodiments (with reference to the attached drawings).

### BRIEF DESCRIPTION OF THE DRAWINGS

FIG. 1 is a front view showing a main portion of a joining device of an object to be detected according to an embodiment of the present invention;

FIG. 2 is a side view showing a solder ball joining device that is the joining device of an object to be detected according to a first embodiment of the present invention;

FIG. 3A is a partially cross-sectional view showing a main portion (III) of a soldering device shown in FIG. 2, which shows a process of ejecting a solder ball;

FIG. 3B is a partially cross-sectional view showing the main portion (III) of the soldering device shown in FIG. 2, which shows a process of ejecting the solder ball;

FIG. 3C is a partially cross-sectional view showing the main portion (III) of the soldering device shown in FIG. 2, which shows a process of ejecting the solder ball;

FIG. 3D is a partially cross-sectional view showing the main portion (III) of the soldering device shown in FIG. 2, which shows a process of ejecting the solder ball;

FIG. 4 is a block diagram showing the soldering device shown in FIGS. 3A to 3D;

FIG. 5A is a diagram showing a relationship between an imaging region and a pixel in a state where the solder ball exists;

FIG. 5B is a diagram showing a relationship between the imaging region and the pixel in an area which is selectively extracted from FIG. 5A;

FIG. 5C is a diagram showing a relationship between the imaging region and the pixel in a state where no soldering ball exists;

FIG. 5D is a diagram showing a relationship between the imaging region and the pixel in an area which is selectively extracted from FIG. 5C;

FIG. 6 is a diagram showing an integrator circuit using a CMOS;

FIG. 7A is a flow chart showing a process of supplying the solder ball to a second stopper from a reservoir;

FIG. 7B is a flow chart showing a process of supplying the solder ball from the second stopper to a nozzle assembly;

FIG. 7C is a flow chart showing a process of detecting the presence or absence of the soldering ball and soldering;

FIG. 8 is a schematic diagram showing a solder ball joining device according to a second embodiment of the present invention;

FIG. 9A is a side view showing a main portion of the solder ball joining device shown in FIG. 8;

FIG. 9B is a cross-sectional view showing the nozzle assembly shown in FIG. 9A, which shows a process of ejecting the solder ball.

FIG. 9C is a cross-sectional view showing a nozzle assembly shown in FIG. 9A, which shows a state in which the solder ball is attached under pressure;

FIG. 10 is a block diagram showing the soldering device of FIGS. 3A to 3D;

FIG. 11 is a flow chart showing a soldering process;

FIG. 12 is a cross-sectional view showing a nozzle assembly according to a modification of the second embodiment of the present invention; and

FIG. 13 is a partially cross-sectional view showing a conventional soldering device.

### DESCRIPTION OF THE EMBODIMENTS

Hereinafter, a description will be given of a joining device for an object to be detected according to embodiments of the present invention with reference to the accompanying drawings. In the drawings, identical parts are denoted by identical reference symbols.

### Embodiment Mode

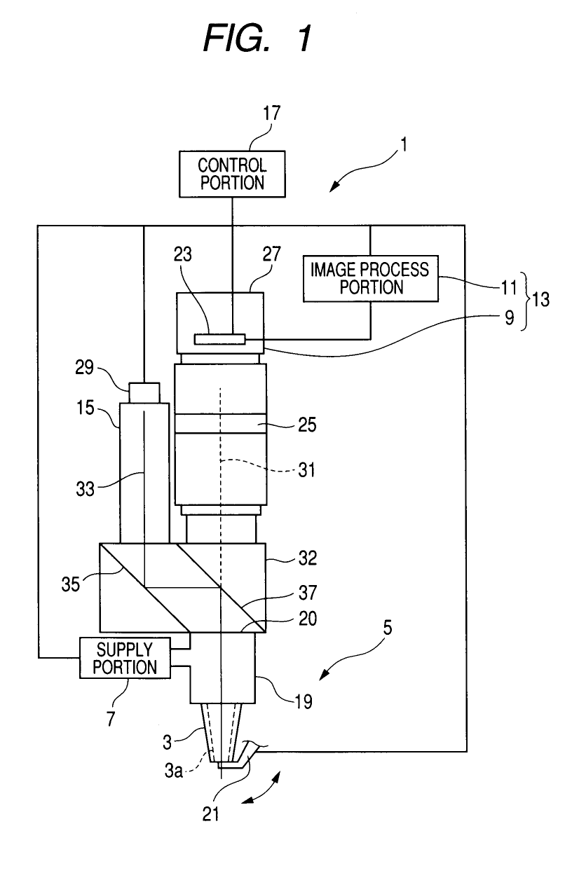

FIG. 1 is a side view showing a joining device according to an embodiment of the present invention. A joining device 1 includes: a nozzle assembly 5 that is an object hold portion that holds an object to be detected with electrical conductivity and no translucency, and has a nozzle 3 that ejects the object to be detected (or ejection material) from a nozzle opening 3a at the leading end; a supply portion 7 that supplies the electrically conductive member to the interior of the nozzle assembly 5; a detection portion 13 that determines whether or not the electrically conductive member is located at a predetermined position; an irradiation portion 15 that irradiates a heat ray for melting the electrically conductive member; and a control portion 17 that drives the detection portion 13 after the object to be detected has been supplied to the interior of the nozzle assembly 5 by the supply portion 7 within the nozzle assembly 5. Also, the detection portion 13 includes an imaging portion 9 that images an image signal in a predetermined region having the nozzle opening 3a within the nozzle 3 of the nozzle assembly 5, and an image process portion 11 that determines that there is no object to be detected in the case where an integral value obtained by integrating the image signal does not exceed a predetermined value. Hereinafter, the above-mentioned respective elements will be described.

The nozzle assembly 5 includes a nozzle main body 19, the tapered nozzle 3 which is concentric with the nozzle main body 19 and coupled with the lower portion of the nozzle main body 19, and has the nozzle opening 3a, and a stopper 21 that opens or closes the nozzle opening 3a.

The stopper 21 is formed of a thin plate member whose side surface is substantially L-shaped, and its thickness needs to be adjusted so as to support the object to be detected which is positioned at the nozzle opening 3a in cooperation with the peripheral wall of the nozzle 3 that forms the nozzle opening 3a. Hence, it is unnecessary that the stopper 21 should perfectly close the nozzle opening 3a. In FIG. 1, the stopper 21 closes the nozzle opening 3a. The nozzle opening 3a is opened or closed by moving or swinging the stopper 21 (in a direction indicated by an arrow of the figure) by a stopper drive portion (not shown). Also, the internal space of the nozzle main body 19 communicates with a solder accommodation space of the nozzle 3, and the electrically conductive member that has been transported into the internal space of the nozzle main body 19 from the supply portion 7 that will be described later is moved to the nozzle opening 3a.

Also, the upper surface of the nozzle main body 19 is formed of a shield member 20 having a light transmitting capability so as to guide a light from an optical unit 32 that will be described later. In this way, the internal space of the nozzle assembly 5 is formed with a hermetically sealed space except for the nozzle opening 3a.

The detection portion 13 and the irradiation portion 15 are disposed above the nozzle assembly 5. The detection portion 13 includes: an imaging portion 9 having a casing 27, an imaging device 23 such as a CCD or a CMOS, which is arranged within the casing 27, and an imaging lens 25 of an optical system which is arranged on an imaging optical path that extends from the nozzle opening 3a to the imaging device 23; and the image process portion 11 that processes an image according to an image signal sent from the imaging device 23, and discriminates whether or not the electrically conductive member exists at a predetermined position. Also, an imaging optical axis 31 of the imaging device 23 is arranged so as to pass through substantially the center of the nozzle opening 3a.

The irradiation portion 15 includes a light source 29 that irradiates a heat ray downward in the drawing in order to melt the object to be detected. In this embodiment, an irradiation optical axis 33 of the light source 29 is substantially in parallel to the imaging optical axis 31 of the imaging portion 13. Also, the heat ray from the light source 29 is guided into the nozzle assembly 5 by means of the optical unit 32 that will be described later, and passes through substantially the center of the nozzle opening 3a. In this way, the irradiation optical path of the heat ray and the imaging optical path substantially coincide with each other within at least the nozzle opening 3a. Accordingly, the internal space of the nozzle assembly 5 functions as the imaging optical path and the irradiation optical path.

The optical unit 32 is interposed between the irradiation portion 15 and the detection portion 13, and the nozzle assembly 5. A reflection mirror 35 that is disposed on the heat ray irradiation optical axis 33, and a half mirror 37 that is disposed on the imaging optical axis 31 of the imaging portion 9 are included within the casing of the optical unit 32. Accordingly, the irradiation optical path of the heat ray that advances downward in the vertical direction from the light source 29 is changed rightward by 90 degrees by the reflection mirror 35. Also, the irradiation optical path of the heat ray is changed downward in the vertical direction by means of the half mirror 37, and the heat ray is guided to the interior of the nozzle assembly 5 and the nozzle opening 3a.

The supply portion 7 is a member that supplies the object to be detected to the interior of the nozzle assembly 5. For example, with the structure having an air source that is capable of supplying a compressed gas and a reservoir portion that reserves the object to be detected, the object to be detected is supplied to the interior of the nozzle assembly 5 from the reservoir portion by the aid of an air supplied from the air source.

Further, the control portion 17 is coupled with the light source 29 of the heat ray of the irradiation portion 15, the image process portion 11 of the detection portion 13, the supply portion 7, and the stopper 21 of the object hold portion 305, and controls the operation of the respective members so as to drive the respective members at predetermined timing.

The joining device 1 configured as described above operates as follows. First, the stopper 21 closes the nozzle opening 3a according to an instruction issued from the control portion 17 (a state of FIG. 1). Then, a single object to be detected is supplied to the interior of the nozzle assembly 5 by compressed gas or the like by means of the supply portion 7 according to the instruction issued from the control portion 17.

Subsequently, it is determined by the detection portion 13 whether or not the object to be detected exists in the nozzle opening 3a of the nozzle 3. The imaging portion 9 of the detection portion 13 can be formed of an imaging device using an imaging device such as a CCD or a CMOS. After an image signal of a predetermined region having the nozzle opening 3a has been obtained by the imaging device, the image process portion 11 integrates the image signal and obtains an integration value. Further, in the case where the integration value exceeds a predetermined value, it is determined that the object to be detected is positioned to the nozzle opening 3a. On the contrary, in the case where the integration value does not exceed the predetermined value, it is determined that no object to be detected exists in the nozzle opening 3a.

Also, as the predetermined value for discriminating the presence or absence of the object to be detected, an appropriate value is obtained by conducting experiments as to the case where the object to be detected is positioned at the nozzle opening 3a and as to the case where the object to be detected is not positioned at the nozzle opening 3a in advance. In a process of supplying the object to be detected to the nozzle opening 3a, because the stopper 21 closes the nozzle opening, the above predetermined value can be set by taking into consideration the fact that the nozzle opening 3a is partially closed by the stopper.

Subsequently, when the image process portion 11 determines that the electrically conductive member reaches the nozzle opening 3a, the image process portion 11 issues an arrival signal indicating that the object to be detected reaches the nozzle opening 3a to the control portion 17.

Upon receiving the arrival signal, the control portion 17 issues a drive signal to a drive portion of the stopper 21, and opens the stopper 21. Also, the control portion 17 issues the drive signal to the light source 29 of the irradiation portion 15, and irradiates the object to be detected with a heat ray from the light source 29 of the irradiation portion 15. In this case, the stopper 21 and the irradiation portion 15 are synchronized with each other, and the electrically conductive member is irradiated with the heat ray at the same time when or with a predetermined time difference after the stopper 21 is opened. That is, in the case where there is the predetermined time difference, the electrically conductive member is irradiated with the heat ray after the electrically conductive member has passed through the nozzle opening 3a.

Also, as means for ejecting the electrically conductive member, there are diverse structures such as ejection by the force of gravity, ejection by compressed gas from the supply portion 7, which gas is used for supplying the object to the nozzle assembly, and a provision of an ejection air supply source, that is, an ejection gas supply portion for supplying compressed gas (inert gas such as nitrogen) to the interior of the nozzle assembly 5.

### First Embodiment

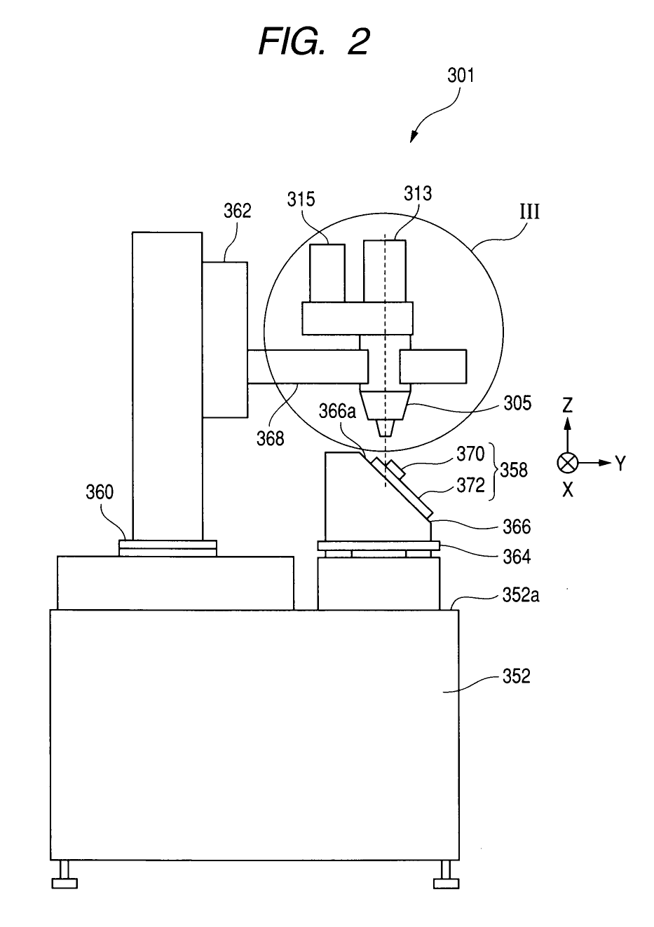

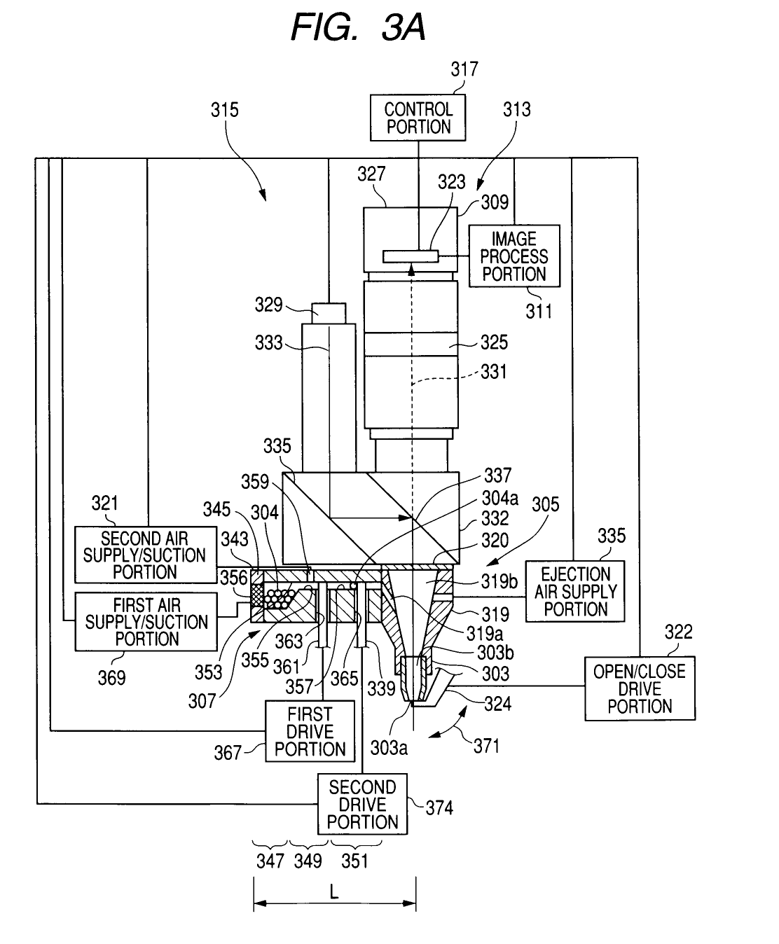

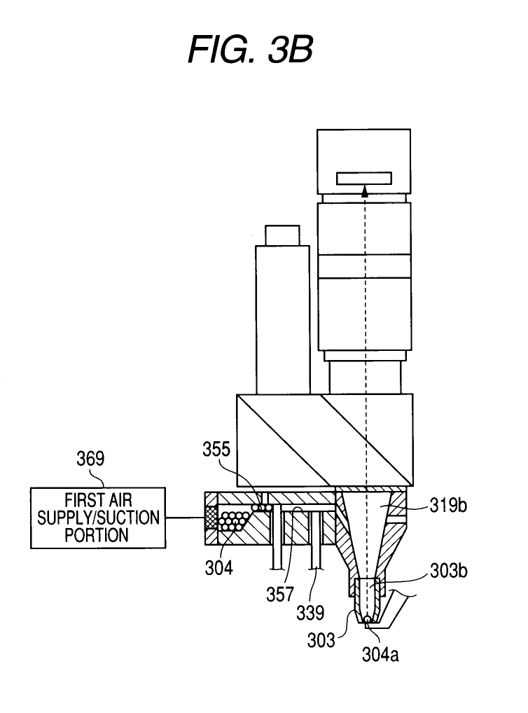

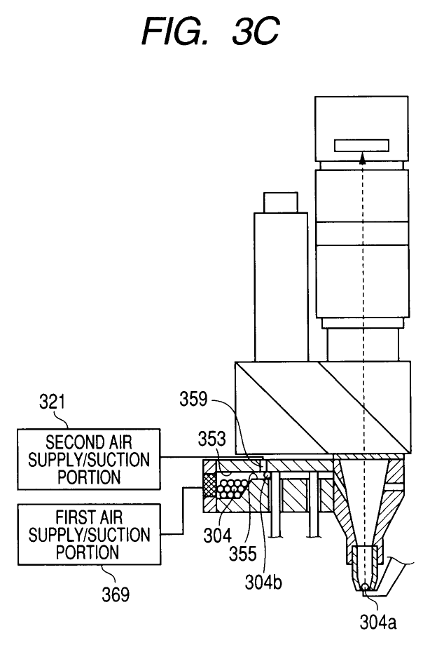

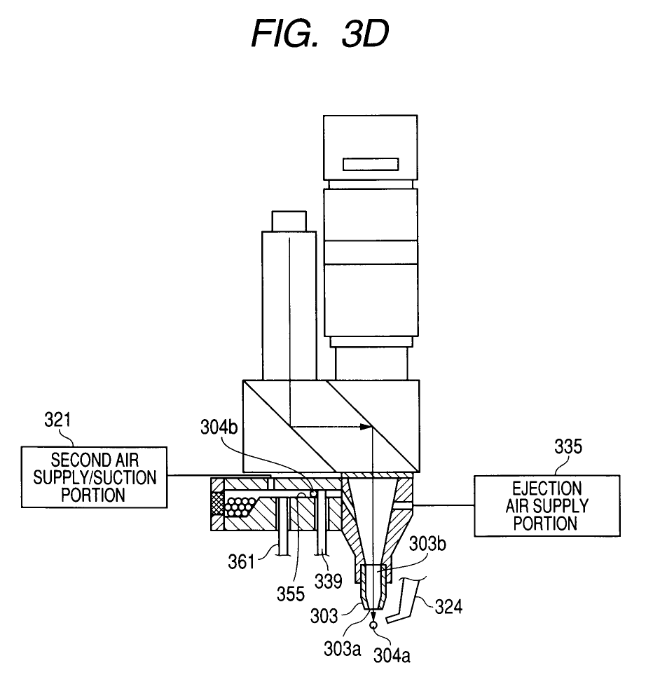

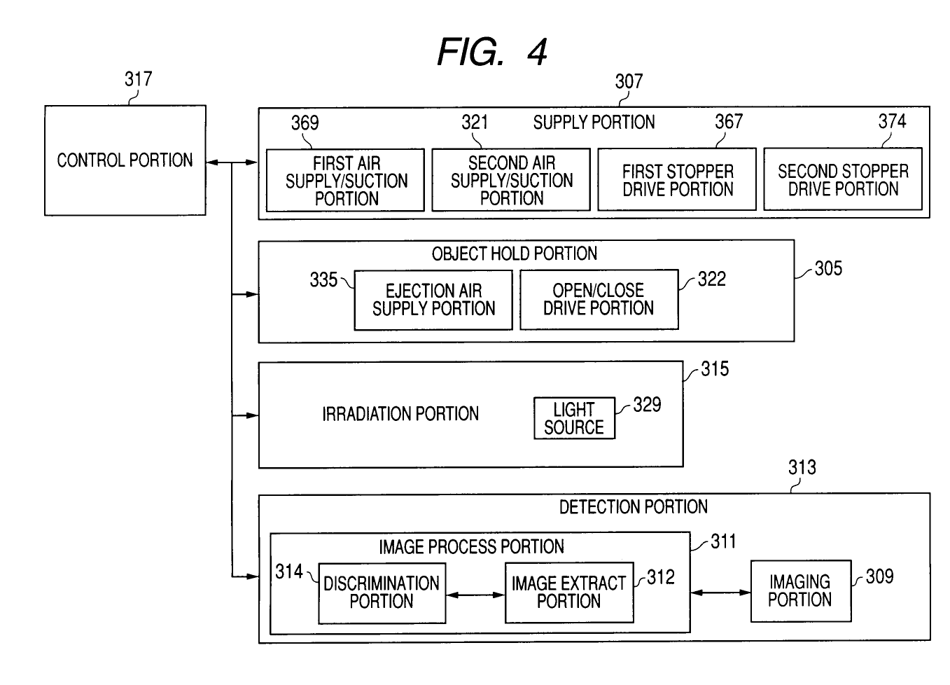

Hereinafter, a description will be given of a first embodiment in which the joining device of the present invention is applied to a soldering device. FIG. 2 is a schematic diagram of the soldering device, and FIGS. 3A to 3D are partially cross-sectional views showing the main portion of the soldering device, which shows a process of ejecting the solder ball. FIG. 4 is a block diagram showing the main portion of the soldering device. FIGS. 3B to 3D omit members unnecessary for description in order to clarify the process of supplying the solder ball to ejecting the solder ball.

A solder ball joining device 301 includes a mount 352, an x-axial motion stage 364 and a y-axial motion stage 360 which are arranged on a work plane 352a of the mount 352 so as to be movable in an x-direction and in a y-direction, respectively, a workpiece tray 366 that transports a workpiece 358 which is fixed on an upper surface of the x-axial motion stage 364, a z-axial motion stage 362 that is fixed on the y-axial motion stage 360 so as to be movable in a z-direction, a nozzle assembly 305 serving as an object hold portion, which is mounted on the z-axial motion stage 362, an imaging portion 313, an irradiation portion 315, a control portion, and a supply portion. The control portion and the supply portion are omitted from FIG. 2 for clarification of the drawing.

The nozzle assembly 305 is fixed to the z-axial motion stage 362 through a nozzle arm 368, and the nozzle arm 368 moves in a vertical direction in FIG. 2. Also, because the imaging portion 313 and the laser irradiation portion 315 are mounted on the nozzle assembly 305, the imaging portion 313 and the laser irradiation portion 315 move in the z-axial direction together with the move of the nozzle assembly 305.

Further, because the z-axial motion stage 362 is fixed to the y-axial motion stage 360, the z-axial motion stage 362 can move in the y-axial direction (lateral direction in FIG. 2). On the other hand, the move of the workpiece 358 in the x-axial direction (direction into and out of the page of FIG. 2) is conducted by moving the workpiece tray 366 that is fixed to the x-axial stage 364.

A workpiece mount surface 366a of the workpiece tray 366 is inclined with respect to the vertical direction, and the workpiece 358 is mounted on the workpiece mount surface 366a to join the electrodes. In this embodiment, an electronic part used for the hard disk is used as the workpiece 358, and more particularly, a flexure 372 that is equipped with a magnetic head slider 370. The electrode of the magnetic head slider 370 and the electrode of the flexure 372 are joined together by soldering with the solder ball. In this case, both of those electrodes are arranged so as to have an angle of 90 degrees, the solder ball is disposed at a corner portion that is formed by those electrodes, and the solder ball is melted by a laser beam to electrically join those electrodes.

Hereinafter, a description will be given of the main portion of the solder ball joining device 301. The main portion of the solder ball joining device 301 includes the nozzle assembly 305 that holds the solder ball 304 which is an electrically conductive member, and ejects the solder ball 304 from an opening 303a at the leading end, a supply portion 307 that supplies the solder ball 304 to the interior of the nozzle assembly 305, the detection portion 313 for determining whether or not the solder ball 304 is located at a predetermined position, the irradiation portion 315 that irradiates a laser beam for melting the solder ball 304, and a control portion 317 that controls the nozzle assembly 305, the supply portion 307, the irradiation portion 315, and the detection portion 313. Also, the detection portion 313 includes an imaging portion 309 that images a predetermined region (imaging region) having the opening 303a within the nozzle 303, and an image process portion 311 that determines whether or not the solder ball 304 is located at the predetermined position on the basis of an image signal that is taken by the imaging portion 309.

The nozzle assembly 305 includes a nozzle main body 319 whose upper portion is formed of a shield member 320 having a light transmitting capability, the tapered nozzle 303 which is concentric with the nozzle main body 319 and coupled with the lower portion of the nozzle main body 319, and has the nozzle opening 303a, and a substantially reverse L-shaped stopper 324 that opens or closes the nozzle opening 303a. The L-shaped stopper 324 is moved by a drive unit such as a known piezoelectric element (in a direction indicated by an arrow 371) to open or close the nozzle opening 303a.

In FIG. 3A, the L-shaped stopper 324 closes the nozzle opening 303a. Also, the internal space 319b of the nozzle main body 319 communicates with a solder accommodation space 303b of the nozzle 303, and when the solder ball 304 is conveyed to the interior of the internal space 319b of the nozzle main body 319 from the supply portion 307 that will be described later, the solder ball 304 moves in the vicinity of the nozzle opening 303a.

The inner diameter of the internal space 319b of the nozzle main body 319, the inner diameter of the solder accommodation space 303b of the nozzle 303, and the diameter of the opening 303a are sized to be slightly larger than at least the outer diameter of the solder ball 304. The solder ball 304 can freely move within the solder accommodation space 303b.

Also, the peripheral wall of the nozzle main body 319 is connected with the supply portion 307 that will be described later. The solder ball 304 supplied from the supply portion 307 is introduced into the internal space 319b of the nozzle main body 319 through a solder ball supply port 319a that penetrates the peripheral wall of the nozzle main body 319.

Further, the nozzle main body portion 319 is connected with an ejection air supply portion 335 for ejecting the solder ball 304, and the ejection air supply portion 335 supplies compressed gas such as nitrogen to the internal space 319b through a hole that penetrates the peripheral wall of the nozzle main body portion 319.

The detection portion 313 and the irradiation portion 315 are disposed above the nozzle assembly 305. The detection portion 313 includes the imaging portion 309 having the CMOS 323 of an imaging device which is disposed within the casing 327 and an imaging lens 325 that constitutes the optical system, and the image process portion 311 that processes the image signal which is obtained from the CMOS 323, and discriminates whether or not the solder ball 304 exists at a predetermined position. In this embodiment, the CMOS 323 of ⅙ inches is used. Also, the CMOS 323 of the imaging portion 313 is arranged so as to pass through substantially the center of the nozzle opening 303a.

The irradiation portion 315 includes a laser light source 329 that irradiates a laser beam downward in FIG. 3 in order to melt the solder ball 304. In this embodiment, an irradiation optical axis 333 of the light source 329 is substantially in parallel to an imaging optical axis 331 of the imaging portion 315. The laser beam is guided into the internal space 319b of the nozzle assembly 305 by means of the optical unit 332 that will be described later, and passes through substantially the center of the nozzle opening 303a. That is, the internal space 319b and the solder accommodation space 303b in the interior of the nozzle assembly 305 also function as a laser path. Also, the irradiation optical path that extends from the laser light source 329 to the nozzle opening 303a is bent by the optical unit 332 that is disposed on the irradiation optical axis.

The optical unit 332 is interposed between the irradiation portion 315 and the imaging portion 309, and the nozzle assembly 305. The optical unit 332 includes a mirror 335 that is disposed on the irradiation optical axis 333 of the irradiation portion 315, and a half mirror 337 that is disposed on the imaging optical axis 331 of the imaging portion 309. With the above structure, the irradiation optical path of the laser beam from the light source 329 is changed rightward by 90 degrees by the mirror 335. Also, the irradiation optical path of the laser beam is reflected downward in the vertical direction by means of the half mirror 337, and the laser beam is guided to the nozzle opening 303a through the shield portion 320 of the nozzle assembly 305. That is, within the nozzle assembly 305, the imaging optical path of the imaging portion 313 and the irradiation optical path 333 of the irradiation portion 315 substantially coincide with each other.

Now, the supply portion 307 will be described. The supply portion 307 includes a supply portion main body 343 that is mounted to a side portion of the nozzle assembly 305, and opened at one side, and an end plate 345 that closes an opening of the supply portion main body 343. Further, the supply portion main body 343 includes a reservoir portion 347, an arrangement portion 349, and a convey portion 351.

The reservoir portion 347 of the supply portion main body 343 includes a reservoir space 353 that is defined by the end plate 345 and a concave disposed in the interior of the supply portion main body 343, and reserves the solder ball 304. The arrangement portion 349 continuous to the reservoir portion 347 has an arrangement path 355 that communicates with the reservoir space 353. Further, the convey portion 351 is continuous to the arrangement portion 349. A conveyance path 357 that communicates with the arrangement path 355 is disposed within the convey portion 351. The convey portion 351 is mounted to the nozzle main body 319 at a side opposite to the arrangement portion 349. The conveyance path 357 of the convey portion 351 communicates with the internal space of the nozzle assembly 305 through the solder ball supply port 319a. That is, the reservoir space 353 communicates with the interior of the nozzle assembly 305. In this embodiment, the arrangement path 355 and the conveyance path 357 extend linearly from the reservoir space 353 in the longitudinal direction of the supply portion main body 343, and its diameter is set to be slightly larger than that of the solder ball 304. Accordingly, the solder balls 304 are aligned within the arrangement path 355 and the conveyance path 357.

Also, a first vent 356 is connected with a first air supply/suction portion 369. Hence, air or suction force which is supplied from the first air supply/suction portion 369 is given to the interior of the reservoir space 353 through the first vent 356.

Further, the arrangement portion 347 is equipped with a second vent 359 that penetrates in a direction substantially orthogonal to a direction along which the arrangement path 355 extends, and communicates with the arrangement path 355. The second vent 359 is coupled with a second air supply/suction portion 321, and air or the suction force supplied from the second air supply/suction portion 321 is supplied to the interior of the arrangement path 357 through the second vent 359. Accordingly, air or the suction force is given to the interior of the arrangement path 355 from a direction substantially perpendicular to the arrangement path.

Also, a first stopper accommodation path 363 that communicates with the arrangement path 355 and detachably accommodates the first stopper 361 is disposed in a boundary region of the arrangement path 355 and the conveyance path 357.

Also, it is preferable that a length of the arrangement path that extends from the center of the second vent to a surface of the first stopper 361 at the reservoir portion 347 side ranges from substantially the same dimension as the outer diameter of the solder ball to the dimension of about 1.5 times of the outer diameter. Also, the distance of the arrangement path 355 extending from a surface of the first stopper 361 at the reservoir portion 347 side to the reservoir space 353 is set to at least a length of the one solder ball 304. Hence, when air is supplied from the second air supply/suction portion 321 in a state where the solder balls 304 are aligned within the arrangement path 355, and a leading solder ball 304 in the line is abutted against the first stopper 361, the leading solder ball can be separated from the remaining solder balls.

Further, the convey portion 349 is equipped with a second stopper accommodation path 365 that communicates with the conveyance path 357 and detachably accommodates the second stopper 339. It is preferable that a distance between the first accommodation path 363 and the second stopper accommodation path 365 is set to be longer than at least an outer diameter of the one solder ball.

The first stopper 361 and the second stopper 339 are connected with a first stopper drive portion 367 and a second stopper drive portion 374 for driving the first stopper 361 and the second stopper 339, respectively. Accordingly, the first stopper 361 and the second stopper 339 are driven and detachably inserted into the accommodation paths 363 and 365, respectively, to open or close the arrangement path 355 and the conveyance path 357.

Also, even if the first stopper 361 and the second stopper 339 close the arrangement path 355 and the conveyance path 357, in order to supply air to the arrangement path 355 and the conveyance path 357, the first stopper 361 and the second stopper 339 are adjusted in dimension with respect to the arrangement path and the conveyance path.

It is needless to say that a distance (L) from the end plate 345 of the supply portion main body 307 to the center of the opening 303a of the nozzle 303 of the nozzle assembly 305 can be appropriately changed.

Further, the control portion 317 is coupled with the light source portion 329 of the irradiation portion 315, the image process portion 311 of the detection portion 313, the supply portion 307, and an L-shaped stopper open/close drive portion 322 of the object hold portion 305 as shown in a block diagram of FIG. 4, and issues an instruction to drive the respective portions at predetermined timing.

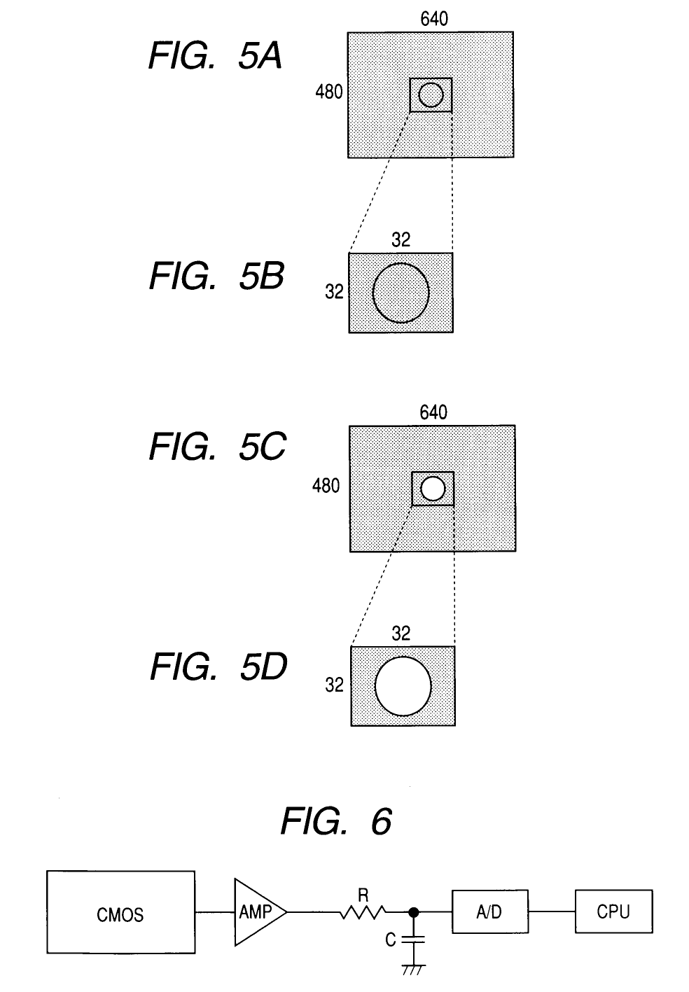

Then, a description will be given of a process of determining whether or not the solder ball exists at the predetermined position with reference to FIGS. 5 and 6. FIGS. 5A to 5D show the relationship between the imaging region and the pixel, FIG. 5A shows a state in which the solder ball exists, FIG. 5B shows an area which is selectively extracted from FIG. 5A, FIG. 5C shows a state in which no solder ball exists, and FIG. 5D shows an area which is selectively extracted from FIG. 5C. FIG. 6 shows an integrator circuit using a CMOS.

The number of pixels in the imaging region shown in FIGS. 5A to 5D is 640×480 pixels. The diameter of the nozzle opening 303a to be used is about 70 to 200 μm. Also, in the imaging device of the CMOS type, an image signal is integrated by the aid of an integrator circuit shown in FIG. 6. The integrator circuit conducts integration to add an image signal of the pixels in an extracted predetermined area among the image signals from the CMOS to a capacitor.

Under the above conditions, relatively, the area of the nozzle opening within the imaging region is remarkably smaller than the area of other regions (peripheral wall within the nozzle). For example, when the image signals of the entire imaging region are integrated together to obtain an integration value by the aid of the CCD type imaging portion, in the case where the nozzle opening is not closed by the solder ball, because relatively, the area of the nozzle opening region is extremely smaller than other areas, a light-dark difference becomes small. As a result, it is difficult to discriminate that no solder ball exists. Also, because the nozzle opening exists even in the region closed by the L-shaped stopper, it is further difficult to discriminate the presence or absence of the solder ball from the integration value of the entire imaging region.

In the case of the CCD, there can be proposed a method in which the image signals in the entire imaging region have been converted into the image data by the A/D converter, and then only image data of the respective pixels in the predetermined area are added together to conduct integration. However, because it is necessary to digitalize the image signals of the entire imaging region, there is a limit of shortening the processing time.

Under the above circumstances, in this embodiment, CMOS is used as the imaging device 323. The image signals only in the predetermined area of 32×32 pixels having the nozzle opening are extracted from the image signals that have been imaged by the imaging portion 309 by the image extraction portion 312, and integrated to obtain an integration value. In the discrimination portion 314, in the case where the integration value exceeds the predetermined value, it is discriminated that the solder ball exists. In the case where the integration value does not exceed the predetermined value, it is discriminated that no solder ball exists in the nozzle opening. In the predetermined area, because the area corresponding to the nozzle opening (portion that becomes light in the case where no solder ball exists) can be larger than the area of other portion (dark portion) (refer to FIGS. 5B and 5D), the light-dark difference becomes distinct, and it is easy to discriminate the presence or absence of the solder ball.

Further, in order to transfer the image signals of 640×480 pixels, a period of time of about 33 msec is required. However, the transfer of the image signal only in the predetermined area of 32×32 pixels can be conducted in about 2 msec. Accordingly, depending on the processing speed of the discrimination portion or the like, the discrimination results of the presence or absence of the solder ball can be transferred in about 5.5 msec after the solder ball 304 closes the nozzle opening 303a. Hence, in order to conduct the process of discriminating the presence or absence of the solder ball at high speed and with high precision, the CMOS is preferable.

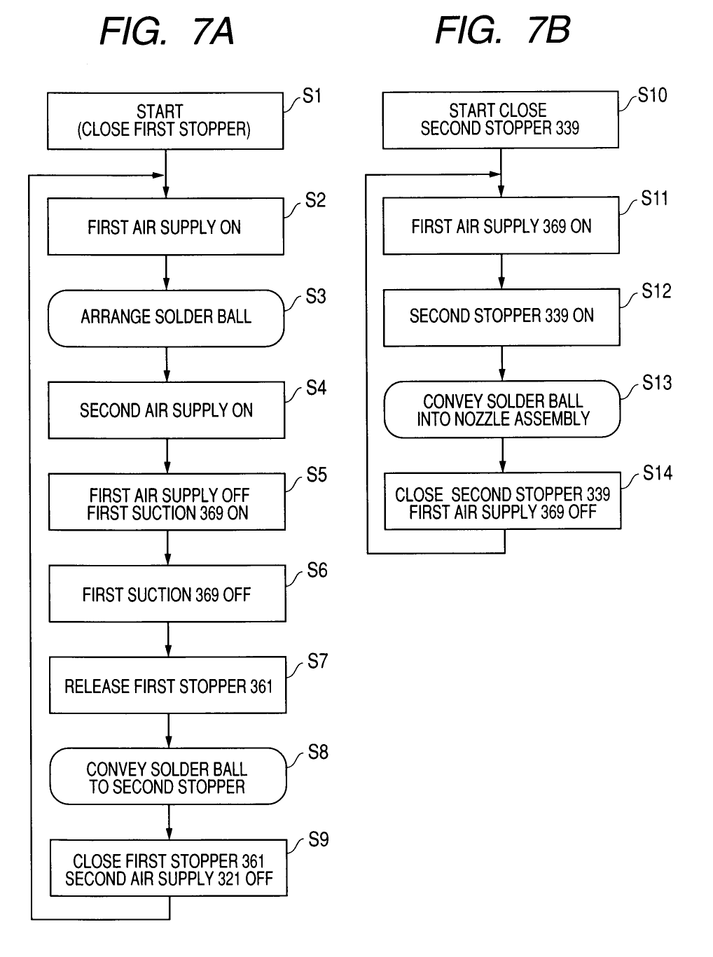

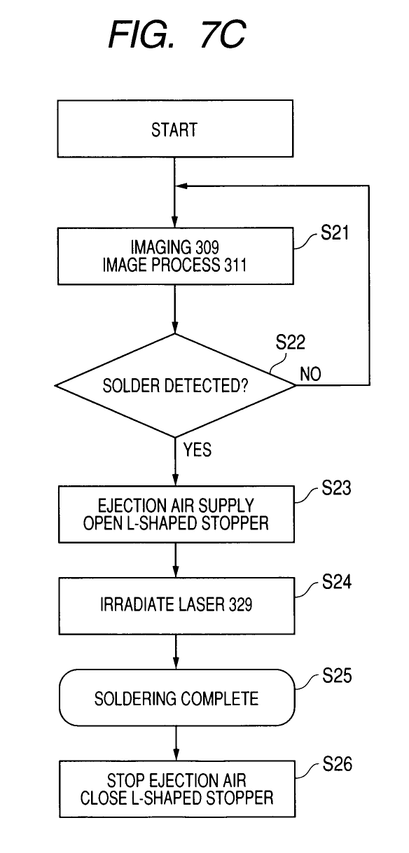

Subsequently, a description will be given of a soldering process in the soldering device structured as described above with reference to FIGS. 7A to 7C. FIG. 7A is a flow chart showing a process of supplying the solder ball to the second stopper from the reservoir. FIG. 7B is a diagram showing a process of supplying the solder ball from the second stopper to the nozzle assembly. FIG. 7C is a flow chart showing a process of detecting the presence or absence of the solder ball and soldering.

First, prior to the soldering process, the workpiece 358 that is an object to be soldered is fixed to the workpiece mount surface 366a. Then, a relation between the nozzle assembly 305 and the workpiece 358 is positioned. This is conducted by moving the workpiece 358 by the aid of the x-axial motion stage 364, and moving the nozzle assembly 357 by the aid of the y-axial motion stage 360 and the z-axial motion stage 362.

Then, as show in FIG. 3A, a first solder ball 304a reaches the second stopper 339. That is, the first solder ball 304a reaches the second stopper 339 through the processes of Step S1 to Step S8 of FIG. 7A. The first and second stoppers 361 and 339 are in the closed state.

Subsequently, as shown in FIG. 3B, the solder ball 304 is aligned within the arrangement path 355 (Step S3 of FIG. 7A) by the aid of compressed air supplied from the first air supply/suction portion 369 (Step S2 of FIG. 7A). On the other hand, the compressed air supplied from the first air supply/suction portion 369 also effects the first solder ball 304a (Step S11 of FIG. 7B). Then, the second stopper 339 is opened according to a request from the control portion 317 of the solder ball joining device 301 in a state where the first stopper 361 is closed (Step S12 of FIG. 7B), and the conveyance path 357 is opened. The first solder ball 304a passes through the interior of the internal space 319b of the nozzle main body 319, and is guided into the solder accommodation space 303b of the nozzle 303 (Step S13 of FIG. 7B). Thereafter, the second stopper 339 is closed, and the first air supply/suction portion 369 stops (Step S14 of FIG. 7B).

After the solder ball 304 has been aligned within the arrangement path 355, the second air supply/suction portion 321 operates so that compressed air is supplied into the arrangement path 355 through the second vent 359 (Step S4 of FIG. 7A). As a result, a second solder ball 304b is separated from other solder balls 304.

Subsequently, the air supply conducted by the first air supply/suction portion 369 stops, and the suction force caused by the first air supply/suction portion 369 is given (Step S5 of FIG. 7A). As a result, other solder balls 304 except for the second solder ball 304b are returned to the interior of the reservoir space 353 (FIG. 3C).

As described above, the compressed air that is supplied from the first air supply/suction portion 369 is used to convey the first solder ball 304a that is stopped by the second stopper 339, and the solder ball within the reservoir. Hence, the air supply start and stop conducted by the first air supply/suction portion 369 are appropriately controlled by the control portion so that the process of arranging the solder balls in the reservoir portion and the timing of conveying the solder balls stopped by the second stopper 339 to the interior of the nozzle assembly coincide with each other.

Then, the suction conducted by the first air supply/suction portion 369 stops (Step S6 of FIG. 7A), the first stopper 361 is released (Step S7 of FIG. 7A), and the arrangement path 355 is released. The second solder ball 304b reaches the second stopper 339 and stops due to the compressed air supplied from the second air supply/suction portion 321 (Step S8 of FIG. 7A, and FIG. 3D). Then, the first stopper 361 is closed, and the second air supply/suction portion 321 stops (Step S9 of FIG. 7A).

On the other hand, in Step S13 of FIG. 7B, it is determined whether or not the first solder ball 304a that passes through the conveyance path 357 and is located within the nozzle 303 is located at a predetermined position, that is, supported by the upper surface of the L-shaped stopper 324 and the peripheral wall that defines the opening 303a.

In the process of determining the presence or absence of the solder ball, only the image signals in a predetermined area are extracted from the imaging signals that have been imaged by the imaging portion 309 according to an instruction from the image extraction portion 312 of the image process portion 311, and the image signals are integrated together to obtain an integration value (Step S21 of FIG. 7C). Then, in the case where the integration value exceeds a predetermined value, the discrimination portion 314 determines that the first solder ball 304a is positioned to the nozzle opening 303a. Also, in the case where the integration value is lower than the predetermined value, the discrimination portion 314 determines that the first solder ball 304a does not reach the opening 303a, and the above operation is repeated until the integration value becomes equal to or larger than the predetermined value (Step S22 of FIG. 7C).

Then, when the discrimination portion 314 determines that the first solder ball 304a reaches the opening 303a, a drive signal is issued to the open/close drive portion 322 and the ejection air supply portion 335 from the control portion 317, and the L-shaped stopper 324 is opened, and the ejection air is supplied (Step S23 of FIG. 7C). Then, the first solder ball 304a is discharged to the external of the nozzle 303 (FIG. 3D). That is, the first solder ball 304a is discharged in a state where the second solder ball 304b is stopped by the second stopper 339. The drive timings of the open/close drive portion 322 and the ejection air supply portion 335 can be synchronized by the control portion.

Further, after the first solder ball 304a has passed through the nozzle opening 303a and then been discharged (Step S23 of FIG. 7C), the light source 329 is driven by the drive signal from the control portion 317, and the first solder ball 304a that is flying is irradiated with the laser beam (Step S24 of FIG. 7C). That is, the solder ball 304a passes through the opening 303a in a solid phase state. The solder ball 304a that has been melted by the laser beam adheres to a predetermined position to conduct electric joint (Step S25 of FIG. 7C). The second stopper 339 is closed, and one process of the joining process is completed (Step S26 of FIG. 7C).

The above-mentioned solder supply and joining process is exemplified by one example, and it is needless to say that the process can be appropriately changed. For example, the imaging process (Step S21 of FIG. 7C) is conducted after the second stopper is closed (Step S14 of FIG. 7B). Alternatively, the imaging process can be conducted before the second stopper is closed. Also, the laser irradiating process (Step S24 of FIG. 7C) is conducted after the L-shaped stopper 324 is opened. Alternatively, the laser irradiating process can be conducted before the L-shaped stopper 324 is opened, or the solder ball 304a can be irradiated with the laser beam to the degree that the solder ball 304a is not melted.

Finally, the drive signal is supplied to the open/close drive portion 322 from the control portion 317, to thereby close the opening portion 303a by the L-shaped stopper 324 into a state shown in FIG. 3A. As described above, because the second solder ball 304b is stopped by the second stopper 339 when the leading solder ball of the plurality of continuous solder balls is discharged, a delay is small with respect to a solder ball supply request from the control portion 317 of the solder ball joining device 301, and the ejection interval can be resultantly shortened.

Although, in the above embodiment, air is used for supplying or ejecting the solder ball, it is needless to say that gaseous material can be used instead of the air.

### Second Embodiment

Hereinafter, a description will be given of a second embodiment in which the joining device of the present invention is applied to a soldering device. In the soldering device according to the first embodiment of the present invention, the solder ball is supplied to the interior of the nozzle, and the solder ball is held in the vicinity of the opening portion thereof by means of the stopper, and the solder ball is ejected, and irradiated with a heat ray. In the soldering device according to the second embodiment of the present invention, compressed air is supplied to the interior of the internal space of the nozzle, and the heat ray is supplied to the solder ball to discharge the solder ball in a state where the solder ball is attached under pressure to the nozzle opening portion from the external of the nozzle assembly.

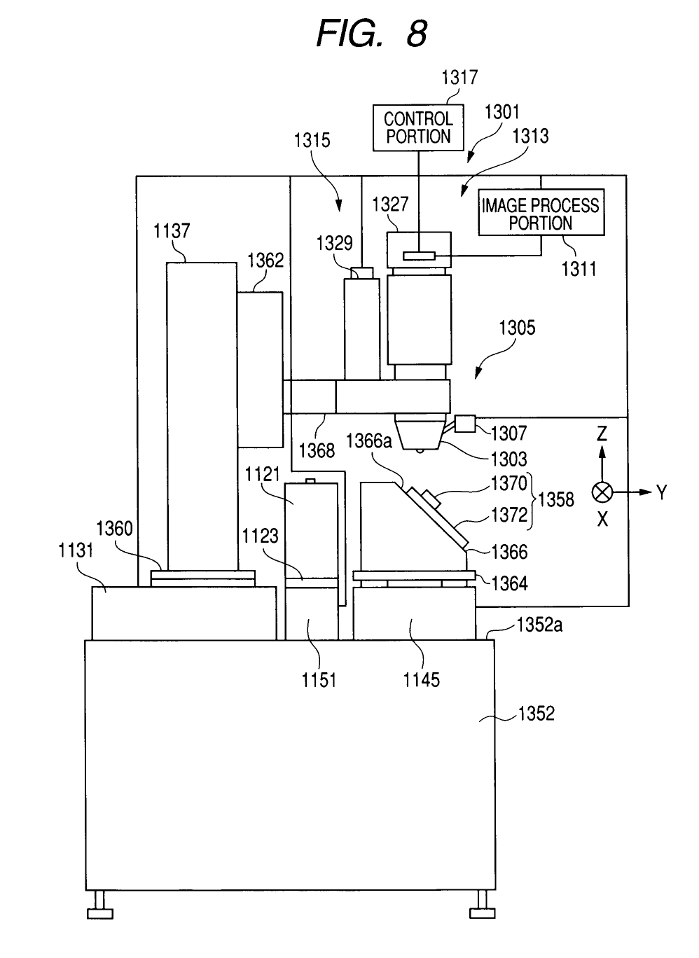

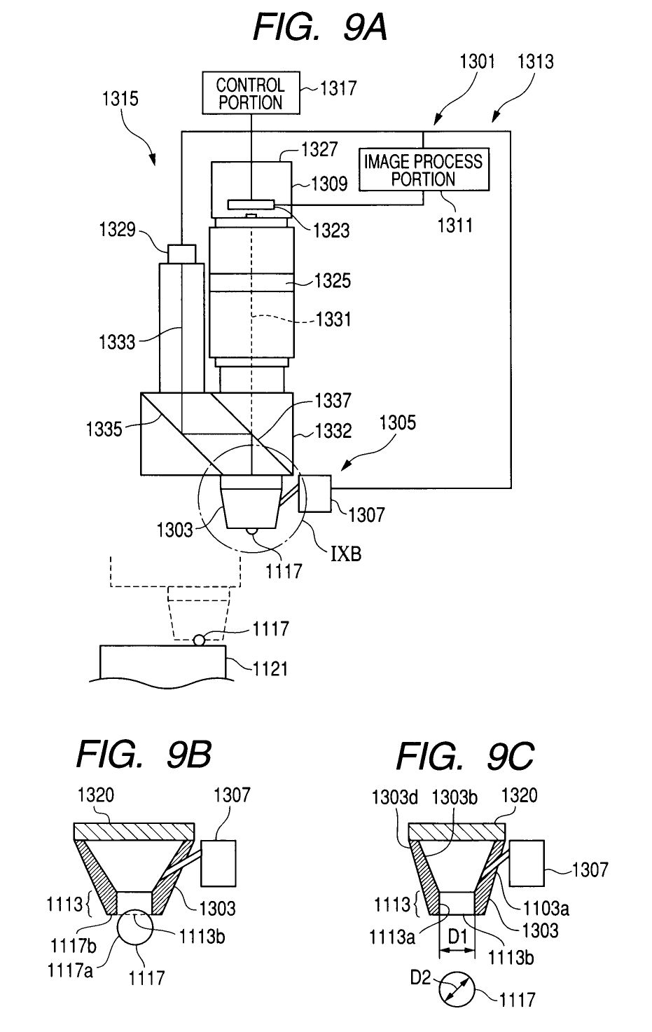

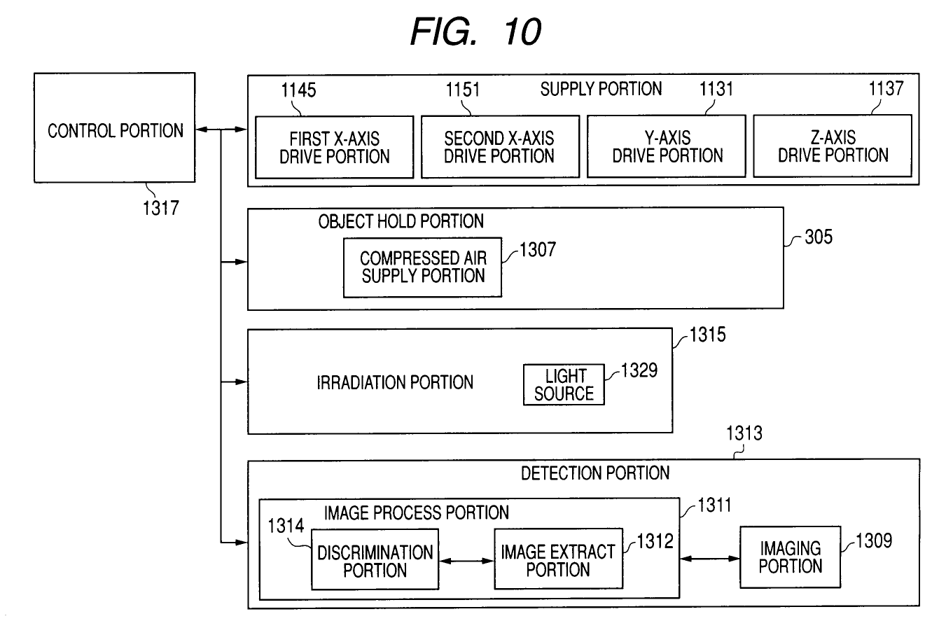

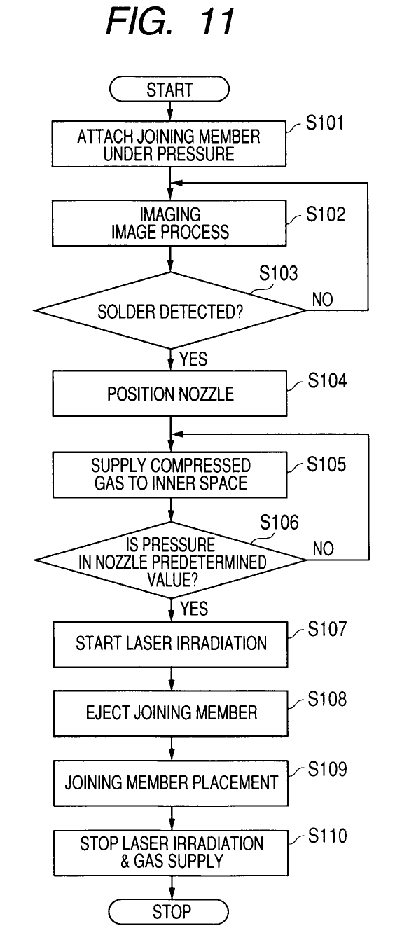

FIG. 8 is a schematic diagram of the soldering device according to the second embodiment of the present invention. FIG. 9A is a front view showing a main portion of the soldering device according to the second embodiment of the present invention. FIG. 9B is an enlarged cross-sectional view showing the nozzle assembly along a plane that passes through the optical axis of the IXB portion, which shows a state in which the solder ball is attached under pressure. FIG. 9C is an enlarged cross-sectional view showing the nozzle assembly along the plane that passes through the optical axis of the IXB portion shown in FIG. 9A, which shows a state in which the solder ball is discharged. FIG. 10 shows a block diagram showing the main portion of the soldering device. FIG. 11 is a flowchart showing a soldering process.

Hereinafter, the structure of the solder ball joining device 1301 will be described. A description will be mainly given of portions of the structure of a solder ball joining device 1301 which are different from the solder ball joining device according to the first embodiment of the present invention.

As shown in FIG. 8, the solder ball joining device 1301 mainly includes a nozzle assembly (object hold portion) 1305, an imaging portion 1313, a laser irradiation portion 1315, a control portion 1317, a mount 1352, an x-axial motion stage 1364 and a y-axial motion stage 1360 which are arranged on a work plane 1352a of the mount 1352 so as to be movable in an x-direction and in a y-direction, respectively, a workpiece tray 1366 that transports a workpiece 1358 which is fixed on an upper surface of the first x-axial motion stage 1364, and a reservoir portion 1121 that reserves the solder ball that is fixed onto the upper surface of the second x-axial motion stage 1364. The reservoir portion 1121 is disposed on the upper surface 1352a of the mount 1352 between the workpiece tray 1366 and a y-axial drive portion 1131.

The nozzle assembly 1305 is fixed to a z-axial motion stage 1362 through a nozzle arm 1368, and the nozzle assembly 1305 can move in the z-direction (vertical direction in FIG. 8) by means of a z-axial drive portion 1137 for driving the z-axial motion stage. Also, because the imaging portion 1313 and the laser irradiation portion 1315 are mounted on the nozzle assembly 1305, the imaging portion 1313 and the laser irradiation portion 1315 move in the z-axial direction integrally with the nozzle assembly 1305.

Further, because the z-axial motion stage 1362 is fixed to the y-axial motion stage 1360, the y-axial drive portion 1131 is driven to move the z-axial motion stage 1362 in the y-axial direction (lateral direction in FIG. 8). On the other hand, the move of the workpiece 1358 in the x-axial direction (direction into and out of the page of FIG. 8) is conducted by moving the workpiece tray 1366 that is fixed to the x-axial stage 1364 by driving a first x-axial drive portion 1145. Similarly, the move of the reservoir portion 1121 for reserving the solder ball in the x-axial direction is conducted by driving the x-axial motion stage 1123 to which the workpiece tray 1366 is fixed by a second x-axial drive portion 1151.

In this case, the y-axial drive portion 1131, the z-axial drive portion 1137, the first and second x-axial drive portions 1145 and 1151 to be used are known in structure. For example, the y-axial drive portion 1131 can be constituted by a motor (not shown), a y ball screw, and a y nut. The y nut having a female screw is fixed to a y slider (for example, a member indicated by reference numeral 1131). The y ball screw whose male screw is disposed on the outer periphery has both ends supported within the casing of the y-axial drive portion so as to be rotatable by ball bearing, and one end of the y-ball screw is coupled with a motor. When the motor is driven, and the y-ball screw is rotated, a y-directional nut that is screwed with the y-ball screw reciprocates along the y-ball screw. When the y-directional nut reciprocates, a y-directional slider moves in the y-direction. Other drive portions can be structured likewise.

Now, the main portion of the solder ball soldering device will be described. As shown in FIG. 9A, the soldering device 1301 includes a nozzle 1303 that ejects the solder ball 1117, a laser irradiation portion 1315, a gas supply portion 1305, a detection portion 1313, and a control portion 1317. Further, the detection portion 1313 includes an imaging portion 1309 that images a predetermined region (imaging region) having an opening 1113a within the nozzle 1303, and an image process portion 1311 that determines whether or not the solder ball 1117 is located at a predetermined position on the basis of an imaging signal that has been taken by the imaging portion 1309.

Also, in FIG. 9A, the reservoir portion 1121 on which the solder balls 1117 are mounted is located in the vicinity of a solder ball joining device 1301. Further, in FIG. 9A, a state in which the nozzle moves to the reservoir portion 1121 is indicated by a broken line. A drive unit (that is, a unit for supplying the solder ball to the opening portion of the nozzle assembly) for moving the nozzle assembly 1305 and attaching the solder ball 1117 to the opening portion 1113 under pressure or the like will be omitted from FIGS. 9A to 9C.

As shown in FIGS. 9B and 9C, the nozzle assembly 1305 includes the nozzle 1303, a pressured air supply portion 1307, and an upper plate 1320. The nozzle 1303 is a cylindrical member that includes an internal space 1303b through which the laser beam passes and to which compressed gas is supplied, which will be described later, and has both ends opened in the longitudinal direction. One end of the nozzle 1303 in the longitudinal direction is closed by the upper plate 1320 that is made of glass through which only the laser beam passes or the like, and the other end has the opening portion 1113 to which the solder ball 1117 is attached under pressure.

The opening portion 1113 has a predetermined length in the longitudinal direction of the nozzle 1303. Also, the opening of the opening portion 1113 is continuous to the internal space 1303b, and has an inner peripheral surface 1113a with a uniform inner diameter D1 (or the radius of curvature). The inner diameter is set to be smaller than at least an outer diameter D2 (or the radius of curvature) of the solder ball 1117.

Further, a peripheral wall 1303d of the nozzle 1303 is coupled with a pressured air supply portion 1307 for ejecting the solder ball 1117, and a pressured air supply portion 1307 supplies compressed gas such as nitrogen to the internal space 1303b through a hole that penetrates the peripheral wall 1303d of the nozzle 1303.

Further, the nozzle assembly 1305 has a supply unit for supplying the solder ball 1117 to a predetermined position of the nozzle 1303. The supply unit is means for making a relative distance between the nozzle 1303 and the reservoir portion 1121 close to or apart from each other, and is constituted by the first x-axial drive portion 1145, the y-axial drive portion 1131, and the z-axial drive portion 1137 as described above.

The imaging portion 1313 and the irradiation portion 1315 are arranged above the nozzle assembly 1305. The detection portion 1313 includes an imaging portion 1309 having a CMOS 1323 of an imaging device which is disposed within a casing 1327 and an imaging lens 1325 that constitutes an optical system, and an image process portion 1311 that processes an image signal obtained from the CMOS 1323, and discriminates whether or not the solder ball 1117 exists at a predetermined position. In this embodiment, the CMOS 1323 of ⅙ inches is used. Also, the CMOS 1323 of the imaging portion 1313 is arranged in such a manner that its imaging optical axis 1331 passes through substantially the center of a nozzle opening 1113a.

The irradiation portion 1315 includes a laser light source 1329 that irradiates a laser beam downward in FIG. 9 in order to melt the solder ball 1117. In this embodiment, an irradiation optical axis 1333 of the light source 1329 is substantially in parallel to an imaging optical axis 1331 of the imaging portion 1315. The laser beam is guided into the internal space 1319b of the nozzle 1303 by means of an optical unit 1332 that will be described later, and passes through substantially the center of the nozzle opening 1113a. That is, the internal space 1303b in the interior of the nozzle 1303 also functions as a laser path. Also, an optical path that extends from the laser light source 1329 to the nozzle opening 1113a is bent by the optical unit 1332 that is disposed on the irradiation optical axis.

The optical unit 1332 is interposed between the irradiation portion 1315 and the imaging portion 1309, and the nozzle assembly 1305. The optical unit 1332 includes a mirror 1335 that is disposed on the irradiation optical axis 1333 of the irradiation portion 1315, and a half mirror 1337 that is disposed on the imaging optical axis 1331 of the imaging portion 1309. With the above structure, the irradiation optical path of the laser beam from the light source 1329 is changed rightward by 90 degrees by the mirror 1335. Also, the irradiation optical path of the laser beam is reflected downward in the vertical direction by means of the half mirror 1337, and the laser beam is guided to the nozzle opening 1113a through the shield portion 1320 of the nozzle assembly 1305. That is, within the nozzle assembly 1305, the imaging optical path of the imaging portion 1313 and the irradiation optical path 1333 of the irradiation portion 1315 substantially coincide with each other.

As shown in FIG. 8, an electronic part used for a hard disk is used as the workpiece 1358, and more particularly, a flexure 1372 that is equipped with a magnetic head slider 1370. In this case, electrodes are arranged with an angle of 90 degrees, the solder ball is disposed at a corner portion that is formed by those electrodes, and the solder ball is melted by a laser beam to electrically join those electrodes.

Also, as shown in FIG. 10, the control portion 1317 is electrically connected to a supply portion that is made up of the y-axial drive portion 1131, the z-axial drive portion 1137, and the first and second x-axial drive portions 1145 and 1151, the nozzle assembly 1305 that is an object hold portion, the laser irradiation portion 1315, and the detection portion 1313. The respective elements operate according to the instructions from the control portion 1317. Needless to say, in order to position the nozzle 1303, the workpiece 1358, and the solder ball 1117 of the reservoir portion 1121, a positioning camera such as a CCD camera is used, and positioning control can be conducted on the basis of an image from the positioning camera, although not shown.

Subsequently, in a process of determining whether or not the solder ball exists at the predetermined position, only differences from the first embodiment (FIGS. 5 and 6) will be described. In the second embodiment of the present invention, it is determined whether or not the solder ball exists after the nozzle opening 1113a is closed by the solder ball by attaching under pressure (refer to FIG. 9B). The image signals only in the predetermined area of 32×32 pixels having the nozzle opening are extracted from the image signals that have been imaged by the imaging portion 1309 which is a CMOS by the image extraction portion 1312, and integrated to obtain an integration value.

In the discrimination portion 1314, in the case where the integration value exceeds the predetermined value, it is discriminated that the solder ball exists. In the case where the integration value does not exceed the predetermined value, it is discriminated that no solder ball exists in the nozzle opening. In the predetermined area, because the area corresponding to the nozzle opening (portion that becomes light in the case where no solder ball exists) can be larger than the area of other portions (dark portion) (refer to FIGS. 5B and 5D), the light-dark difference becomes distinct, and it is easy to discriminate the presence or absence of the solder ball. Further, as opposed to the first embodiment of the present invention, because the stopper is not located just below the nozzle opening, there is no member that shields light, such as the stopper, and the light-dark difference remarkably appears between in the case where the solder ball is disposed at the predetermined position and in the case where the solder ball is not disposed at the predetermined position. Hence, the solder ball can be more surely discriminated.

As in the first embodiment of the present invention, in this embodiment, the transfer of the image signals only in the predetermined area of 32×32 pixels can be conducted at about 2 msec. Accordingly, depending on the processing speed of the discrimination portion or the like, the results of discriminating the presence or absence of the solder ball can be transferred at about 5.5 msec after the solder ball 1117 has closed the nozzle opening 1113a.

Subsequently, a description will be given of a soldering process in the soldering device structured as described above with reference to FIG. 11. Prior to the soldering process, the workpiece 1358 that is an object to be soldered is fixed to a workpiece mount surface 1366a. Then, the processing is shifted to a process of attaching the joining member to the nozzle assembly 1305 under pressure (Step S101). First, the reservoir portion 1121 is moved by the x-axial motion stage 1123 according to an instruction issued from the control portion 1317, and the nozzle assembly 1305 is moved by the y-axial motion stage 1360 and the z-axial motion stage 1362 to satisfy a positional relationship that the nozzle assembly 1305 is apart from the solder ball 1117 of the reservoir portion 1121 upward in the vertical direction by a predetermined distance.

Further, after the nozzle 1303 is moved down and is abutted against the spherical solder ball 1117 that is mounted on the reservoir portion 1121, the opening portion 1113 of the nozzle 1303 is pressed against the solder ball 1117 by a predetermined force, and the solder ball 1117 is pressed into the peripheral edge portion of the opening portion 1113. In this case, the solder ball 1117 is distorted to generate internal stress, and is held by frictional force caused by the internal stress. Accordingly, a diameter portion 1117a of the solder ball 1117 which is the maximum dimensional portion in a cross section along the horizontal plane that extends in the horizontal (lateral) direction in the drawing is positioned at a side closer to the reservoir portion 1121 in the ejection direction x than an abutment portion 1117b of the solder ball 1117 that abuts against a leading end 1113b. That is, the diameter portion 1117a is attached to the nozzle 1303 under pressure in a state where the diameter portion 1117a is positioned outside a contact portion of the opening portion 1113 of the nozzle 1303 and the solder ball 1117. In other words, the solder ball 1117 is positioned outside the nozzle 1303 (in the opening portion or the external space), and no solder ball 1117 exists inside the nozzle 1303.

The maximum dimensional portion means the maximum length of a line segment that connects two arbitrary points on an outer periphery that defines the cross section of the solder ball due to a plane that extends perpendicularly to the ejection direction (vertical direction in this embodiment).

Next, a process of determining the presence or absence of the solder ball will be described. In this process, only the image signals in a predetermined area are extracted from the imaging signals that have been imaged by the imaging portion 1309 according to an instruction issued from the image extraction portion 1312 of the image process portion 1311, and the image signals are integrated together to obtain an integration value (Step S102 of FIG. 11, corresponding to FIG. 5). Then, in the case where the integration value exceeds a predetermined value, the discrimination portion 1314 determines that the first solder ball 1117 is positioned to the nozzle opening 1113a. Also, in the case where the integration value does not exceed the predetermined value, the discrimination portion 1314 determines that the first solder ball 1117 is not attached to the opening 1113a under pressure, and the above operation is repeated until the integration value becomes equal to or larger than the predetermined value (Step S103 of FIG. 11). The predetermined value is set so as to discriminate that the solder ball 1117 is not located at the predetermined position not only in the case where the solder ball 1117 is out of the opening portion 1113, but also in the case where the solder ball 1117 is attached to the opening portion 1113 under pressure, but because the nozzle opening 1113a is not perfectly covered with the solder ball 1117, the internal space is not hermetically sealed, and it is difficult to set a predetermined pressure in the interior of the internal space 1303b.

Then, when it is determined that the first solder ball 1117 covers the nozzle opening 1113a and is located at the predetermined position of the nozzle opening portion 1113 (Step S103 of FIG. 11), a nozzle positioning process that will be described later is started.

In the positioning process, as shown in FIG. 8, the nozzle 1303 is positioned above in the vertical direction from a predetermined position of the workpiece 1358 that is located on the workpiece mount surface 366a of the work tray 1366 (Step S104). Alternatively, the workpiece tray 1366 is moved to relatively position those members in a state where the nozzle 1303 is fixed.

After the positioning process, compressed gas is supplied to the interior of the internal space 1303b from the gas supply portion 1307 (Step S105). It is discriminated whether or not the pressure within the internal space 1303b reaches a predetermined value by the control portion 1317 (Step S106). In the case where it is discriminated that the pressure within the internal space 1303b reaches the predetermined value by the control portion 1317, the solder ball 1117 is irradiated with the laser beam 1333 from the laser irradiation portion 1315 through the internal space 1303b (Step S107). The discrimination of whether or not the interior of the internal space 1303b reaches the predetermined pressure can be conducted by, for example, measuring a predetermined time until the internal space reaches the predetermined pressure after gas is supplied in advance, and discriminating whether or not the predetermined time has elapsed after the gas is supplied by the control portion.

When a portion of the solder ball 1117 which faces the internal space 1303b is irradiated with the laser beam 1333 and heated, the elastic coefficient of the solder ball 1117 is lowered, and accordingly the internal stress is relaxed. In this case, when an urging force of the compressed gas that is filled in the internal space 1303b exceeds a frictional force (holding force) that is generated by the internal stress of the solder ball, an attaching under pressure between the solder ball 1117 and the leading end 1113b of the opening portion 1113 is canceled, and the substantially spherical solder ball 1117 is ejected (FIG. 9C, Step S108).

The ejected solder ball 1117 is placed on a corner portion that is formed by the electrode of the slider 1370 and the electrode of the flexure 1372 on the workpiece tray 1366 (FIG. 8, Step S109). The laser beam 1333 from the laser irradiation portion 1315 continues until the solder ball 1117 is melted.

Then, a signal is conveyed from the control portion 1317 so that the operation of the laser irradiation portion 1315 and the gas supply unit 1307 stop after the solder ball has been perfectly melted at the placement position (the corner portion of the slider 1370 and the flexure 1372) (Step S110). Then, the solder ball 1117 is solidified, and the joint is completed.

As described above, in the joining device 1301 according to this embodiment, after the solid solder ball 1117 has been attached to the opening portion 1113 of the nozzle 1303 under pressure, the compressed gas is supplied to the interior of the internal space, and the laser beam 1333 from the laser irradiation portion 1315 is irradiated to relax the internal stress of the solder ball 1117 (lower the elastic coefficient of the solder ball), and the press attaching of the solder ball 1117 is canceled by the compressed gas. With the above structure, the structure of the soldering device is more simplified than that in the first embodiment, and the control of the soldering device is easy.

Also, because the electrically conductive member is ejected in the solid phase state, no remainder of the electrically conductive member occurs in or in the vicinity of the opening portion of the nozzle.

Further, because the opening portion of the nozzle is opened or closed by the stopper as in the first embodiment of the present invention, there is no case in which the electrically conductive member is dragged by the stopper, and the ejection direction of the electrically conductive member is displaced. Further, it is necessary to synchronize the operation of the stopper with the operation of the laser device with high precision. In the second embodiment of the present invention, when a predetermined pressure is generated in the interior within the nozzle, the ejection timing can be controlled by only the start timing. As a result, the control of the operation is easy, and the structure can be simplified.

### Modification of Second Embodiment

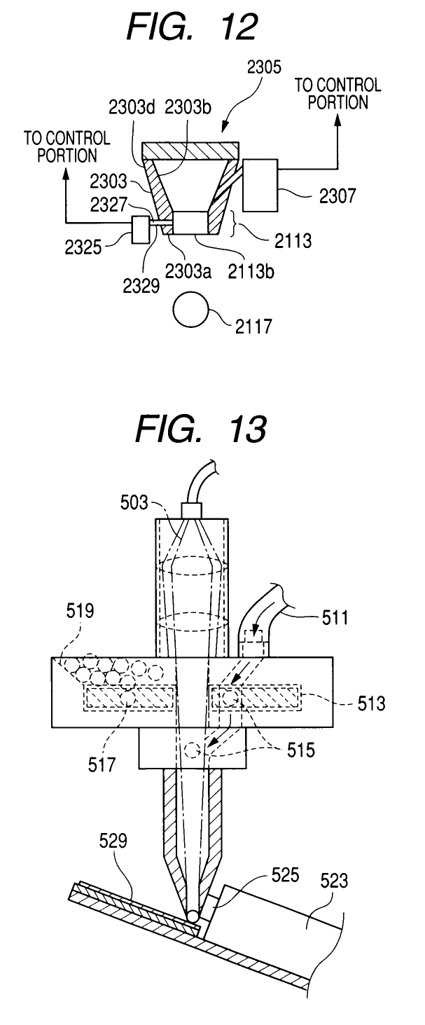

FIG. 12 is a cross-sectional view showing a modification of a nozzle assembly according to the second embodiment of the present invention. A nozzle assembly 2301 of the second embodiment of the present invention is a soldering device having a suction portion 2325 that gives a suction force in order to maintain the pressure attaching state of the solder ball after a solder ball 2117 has been attached to the opening portion 2113 under pressure. The structures of other portions are identical with those of the nozzle assembly of the second embodiment of the present invention, and therefore their details will be omitted.

The suction portion 2325 is connected with a nozzle 2303 by a tube 2329, and the suction force can be supplied to the interior of an internal space 2303b. The suction portion 2325 is disposed on a peripheral wall 2303d of the opening portion 2113 by the tube 2329, and connected with a suction hole 2327 that allows an internal space 2303b to communicate with the external, and extends in the horizontal direction.

With the above structure, when the suction portion 2325 is supplementarily used, the suction force from the suction portion 2325 is supplied to the internal space 2303b so that a negative pressure can be generated in the internal space 2303b. The negative pressure is generated in the internal space 2303b as described above, thereby making it possible to surely maintain the attaching state under pressure in the opening portion 2113 of the solder ball 2117.

A position at which the suction hole 2327 is defined can be appropriately changed, and the internal space 2303b can communicate directly with the external. Alternatively, the suction hole 2327 that is a through-hole that allows the external of the nozzle to communicate with the internal space 2303b is disposed in the nozzle 2303, the single through-hole is used both as the suction hole and the gas introduction path, and the single through-hole is connected to the gas supply portion 2307 and the suction portion 2325. That is, the structure can be appropriately changed when suction force can be supplied to the external of the nozzle 2303 through the opening portion 2113.

Also, the suction portion 2325 is connected to the control portion (corresponding to reference numeral 1317 of FIG. 8) as with the laser irradiation portion (refer to reference numeral 1329 of FIG. 9A) and the gas supply portion 2307, and operates upon receiving a signal issued from the control portion. In the soldering process using the soldering device according to this modification, a difference from the second embodiment of the present invention resides in that after, before, or when the solder ball 2117 is attached under pressure, the suction portion 2325 operates, and the suction force is supplied to the interior of the internal space 2303b. In the case where the suction force is supplied before or when the solder ball 2117 is attached under pressure, the suction force can be supplementarily exerted in the process of attaching the solder ball 2117 to the opening portion 2113 under pressure.

There is proposed that the imaging device is formed of the transmission type or reflection type optical sensor instead of the CMOS. However, for example, in the case of using the transmission type sensor, it is necessary that the arrangement of the sensor be different from a position at which the joining operation is conducted in fact. The nozzle is required to reciprocate between the sensor fixed position and the implementation position of the joining operation, and a reduction in the operation time is limited.

Also, in the case of using the reflection type sensor, the sensor is tapered in such a manner that the inner diameter of the shape of the nozzle interior becomes smaller toward a predetermined position where the solder ball is arranged. Therefore, the sensor receives the reflected light from the nozzle inner surface. As a result, it is difficult to precisely detect the presence or absence of the solder ball. However, in the case of using CMOS as the imaging device, an arbitrary area is selectively extracted among the imaged image signals, thereby making it possible to exclude an influence of the nozzle inner surface.

As described above, there is an advantage in that the CMOS is used as the imaging device as compared with the transmission type or reflection type optical sensor.

In the embodiment mode, embodiments, and the modifications of the present invention, the optical path of the irradiation portion is changed by the optical unit so as to coincide with the optical path of the imaging portion. However, the present invention is not limited to the above structure. Alternatively, the arrangement of the irradiation portion and the imaging portion is replaced with each other, and the optical path of the imaging portion is changed so as to coincide with the optical path of the irradiation portion. That is, the structure is simply required, in which the optical paths of the imaging portion and the irradiation portion coincide with each other in or in the vicinity of the nozzle opening.

Also, the nozzle assembly according to the embodiment mode and the first embodiment of the present invention is formed of two structural elements consisting of the nozzle main body and the nozzle. Alternatively, the nozzle assembly can be formed of a single member as in the second embodiment of the present invention.

Further, in the nozzle assembly according to the embodiment mode and the first embodiment of the present invention, the diameter of the nozzle opening is set to be larger than the diameter of the object to be detected, and the stopper is disposed. Alternatively, there can be provided the nozzle assembly in which the diameter of the nozzle opening is set to be smaller than the diameter of the object to be detected, and the object to be detected is ejected after the object has been melted.

The ejected object of this embodiment mode, the embodiments, and the modifications of the present invention is the solder member. Alternatively, it is possible that an adhesive or the like is used as the ejected object, and a UV laser is used for the irradiation portion.

As the air supply/suction portion according to this embodiment mode and the embodiments of the present invention, there can be used a pressure source that can change over between known positive pressure and negative pressure. The pressure source that gives the pressurized gas and a vacuum source that can suck the air can be individually structured.

The shape and the position of the stopper are not limited to the structures of the above embodiment mode and the first embodiment of the present invention. Also, this embodiment mode, the embodiments, and the modifications are structured so as to melt the solder ball that has been discharged from the nozzle or eject the solder ball that is in the solid phase state from the nozzle. However, the present invention is not limited to those structures. For example, the detection method and the joining device of the present invention can be applied to the structure where the solder ball is melted before discharging (that is, in a state where the solder ball is in contact with the nozzle).

According to the object detection method and the joining device of the present invention, it is possible to rapidly and surely detect that the object to be detected having an extra small diameter reaches the object hold portion. Accordingly, it is possible to precisely manage a time for supplying to the object to be detected in the joining device in a short time, and thus the joining time can be reduced.

Also, because the irradiation optical path and the imaging optical path substantially coincide with each other within the opening, it is unnecessary to conduct the imaging process and the irradiation process at different places, and thus the operating time required for the entire joining process can be quickened.

The present invention can be embodied as many systems without deviating from the essential characteristics. Hence, the above embodiments are made for description, and do not restrict the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application Nos. 2007-17713 filed on Jan. 29, 2007 and 2008-4357 filed on Jan. 11, 2008 which are hereby incorporated by reference herein.

What is claimed is:

1. A detection method of detecting presence or absence of an object to be detected in an object hold portion that is used together with an irradiation portion that irradiates the object to be detected with a heat ray, holds the object to be detected, and has an opening, the detection method comprising:
imaging an image signal in a predetermined region having the opening by an imaging device; and
making an irradiation optical path of the irradiation portion and an imaging optical path of the imaging device substantially coincide with each other within the opening by an optical unit.

2. A detection method according to claim 1, wherein:
the object to be detected comprises an electrically conductive member; and
the object hold portion comprises a nozzle.

3. A detection method according to claim 1, wherein the imaging device comprises a CMOS.

4. A detection method according to claim 2, wherein the imaging device comprises a CMOS.

5. A detection method according to claim 3, further comprising:
integrating the image signal imaged by using the CMOS to calculate an integration value; and
determining, when the integration value does not exceed a predetermined value, that the object to be detected is absent, and determining, when the integration value exceeds the predetermined value, that there is the object to be detected is present.

6. A detection method according to claim 4, further comprising:
integrating the image signal imaged by using the CMOS to calculate an integration value; and
determining, when the integration value does not exceed a predetermined value, that the object to be detected is absent, and determining, when the integration value exceeds the predetermined value, that there is the object to be detected is present.

7. A detection method according to claim 3, further comprising selectively extracting an arbitrary area from a screen range among the image signal for one screen imaged by using the CMOS to calculate an integration value of the image signals within the arbitrary area.

8. A detection method according to claim 4, further comprising selectively extracting an arbitrary area from a screen range among the image signal for one screen imaged by using the CMOS to calculate an integration value of the image signals within the arbitrary area.

9. A detection method according to claim 3, wherein the CMOS is ⅙ inches.

10. A detection method according to claim 4, wherein the CMOS is ⅙ inches.

11. A joining method of ejecting electrically conductive member with a substantially spherical shape to an object to be joined from a nozzle to electrically join the object to be joined, the joining method comprising:
preparing the electrically conductive member having an outer diameter larger than a diameter of an opening portion of the nozzle;
attaching the electrically conductive member to the opening portion of the nozzle from outside of the nozzle under pressure;
detecting presence or absence of the object to be detected by the detection method according to claim 2;
supplying compressed gas into an internal space of the nozzle when it is determined that the object to be detected is present in the detecting process;
irradiating the electrically conductive member attached to the opening portion under pressure with a heat ray through the internal space when the internal space has a predetermined pressure value; and
ejecting the electrically conductive member to the object to be joined by the compressed gas in a solid-phase state.

12. A joining method according to claim 11, wherein the attaching of the electrically conductive member to the opening portion under pressure comprises pressing the nozzle against the electrically conductive member.

13. A joining method according to claim 11, further comprising applying a suction force to the opening portion through the internal space to assist the attaching of the electrically conductive member to the opening portion under pressure.

14. A joining method according to claim 11, further comprising continuing the irradiation of the electrically conductive member with the heat ray after the electrically conductive member is ejected.

15. A joining method according to claim 12, further comprising continuing the irradiation of the electrically conductive member with the heat ray after the electrically conductive member is ejected.

16. A joining method according to claim 13, further comprising continuing the irradiation of the electrically conductive member with the heat ray after the electrically conductive member is ejected.

17. A joining device, comprising:
a nozzle assembly having a nozzle with a nozzle opening portion which communicates with an external space and ejects an ejection material;
a supply portion that supplies the ejection material to the nozzle opening portion;
a detection portion having an imaging portion that images an image signal in a predetermined region having a nozzle opening within the nozzle, and a discrimination portion that determines presence or absence of the ejection material on the basis of the image signal that is imaged;
an irradiation portion that irradiates the ejection material with a heat ray;
an optical member that is disposed on one of an irradiation optical axis and an imaging optical axis so that the irradiation optical path of the irradiation portion and the imaging optical path of the imaging portion coincide with each other at least within the nozzle;
an ejection gas supply portion that introduces compressed gas into an internal space to eject the ejection material; and
a control portion that controls a series of operation of:
supplying the ejection material from the supply portion to eject the ejection material from the nozzle assembly; and
supplying the compressed gas to the internal space and irradiating the ejection material with a heat ray when it is determined by the detection portion that the ejection material exists in the nozzle opening portion.

18. A joining device according to claim 17, wherein:
the imaging portion comprises an optical lens and an imaging device; and
the imaging device comprises a CMOS.

19. A joining device according to claim 18, further comprising a discrimination portion that:
integrates the image signal imaged by using the CMOS to calculate an integration value,
determines that the object to be detected is absent when the integration value that has been obtained does not exceed a predetermined value; and
determines that the object to be detected is present when the integration value exceeds the predetermined value.

20. A joining device according to claim 18, further comprising an area selective extraction portion that selectively extracts an arbitrary area from a screen range among the image signal for one screen imaged by the CMOS,
wherein the discrimination portion makes determination based on the image signal of the arbitrary area.

21. A joining device according to claim 18, wherein the CMOS is ⅙ inches.

22. A joining device according to claim 19, wherein the ejection material is ejected from the nozzle assembly in a solid-phase state.

23. A joining device according to claim 20, wherein the ejection material is ejected from the nozzle assembly in a solid-phase state.

24. A joining device according to claim 22, wherein the supply portion comprises pressure attaching unit that makes the nozzle relatively close to and apart from a reservoir portion that reserves the ejection material, and attaches the ejection material to the opening portion under pressure.

25. A joining device according to claim 23, wherein the supply portion comprises pressure attaching unit that makes the nozzle relatively close to and apart from a reservoir portion that reserves the ejection material, and attaches the ejection material to the opening portion under pressure.

26. A joining device according to claim 24, further comprising a unit that supplementarily attaches the ejection material to the nozzle opening portion from an external side of the nozzle.

27. A joining device according to claim 25, further comprising a unit that supplementarily attaches the ejection material to the nozzle opening portion from an external side of the nozzle.

28. A joining device according to claim 24, wherein:
the ejection material comprises an electric conductive member with substantially spherical shape; and
a diameter of the nozzle opening is smaller than a diameter of the electrically conductive material.

29. A joining device according to claim 25, wherein:
the ejection material comprises an electric conductive member with substantially spherical shape; and
a diameter of the nozzle opening is smaller than a diameter of the electrically conductive material.

30. A joining device according to claim 26, wherein:
the ejection material comprises an electric conductive member with substantially spherical shape; and
a diameter of the nozzle opening is smaller than a diameter of the electrically conductive material.

31. A joining device according to claim 27, wherein:
the ejection material comprises an electric conductive member with substantially spherical shape; and
a diameter of the nozzle opening is smaller than a diameter of the electrically conductive material.
